(19) United States
(12) Patent Application Publication
(10) Pub. No.: US 2024/0107393 A1
(43) Pub. Date: Mar. 28, 2024

(54) METHOD OF DYNAMIC SWITCH INDICATION

(71) Applicant: ZTE Corporation, Shenzhen (CN)

(72) Inventors: Shijia SHAO, Shenzhen (CN); Bo GAO, Shenzhen (CN); Shujuan ZHANG, Shenzhen (CN); Ke YAO, Shenzhen (CN); Yang ZHANG, Shenzhen (CN); Zhaohua LU, Shenzhen (CN)

(21) Appl. No.: 18/521,349

(22) Filed: Nov. 28, 2023

Related U.S. Application Data
(63) Continuation of application No. PCT/CN2022/089594, filed on Apr. 27, 2022.

(51) Int. Cl. H04W 36/00; H04W 76/20

(52) U.S. Cl. CPC H04W 36/0072; H04W 36/0064; H04W 76/20

(57) ABSTRACT

This document relates to a method of dynamic switch indication. A method of wireless communication comprising: transmitting, by a network device, to a wireless communication device, a first parameter indicated by a first signaling message; transmitting, by a network device, to a wireless communication device, a plurality of transmission configuration states by a second signaling message; determining, by the wireless communication device, the plurality of transmission configuration states to a transmission; wherein the plurality of transmission configuration states include transmission configuration indicator (TCI) states.

### CROSS REFERENCE TO RELATED APPLICATIONS

This patent document is a continuation of and claims benefit of priority to International Patent Application No. PCT/CN2022/089594, filed on Apr. 27, 2022. The entire content of the before-mentioned patent application is incorporated by reference as part of the disclosure of this application.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems with respect to reporting or using channel state information.

In one exemplary aspect, a wireless communication method is disclosed. The method includes receiving, by a wireless communication device, from a network device, a first parameter indicated by a first signaling message; receiving, by a wireless communication device, from a network device, a plurality of transmission configuration states by a second signaling message; determining, by the wireless communication device, the plurality of transmission configuration states to a transmission; wherein the plurality of transmission configuration states include transmission configuration indicator (TCI) states.

In another exemplary aspect, another wireless communication method is disclosed. The method includes transmitting, by a network device, to a wireless communication device, a first parameter indicated by a first signaling message; transmitting, by a network device, to a wireless communication device, a plurality of transmission configuration states by a second signaling message; determining, by the wireless communication device, the plurality of transmission configuration states to a transmission; wherein the plurality of transmission configuration states include transmission configuration indicator (TCI) states.

In yet another exemplary aspect, the above-described methods are embodied in the form of a computer-readable medium that stores processor-executable code for implementing the method.

In yet another exemplary aspect, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 shows an example of a wireless communication system that includes a base station (BS) and user equipment (UE).

FIG. 2 is a block diagram example of a wireless communication system.

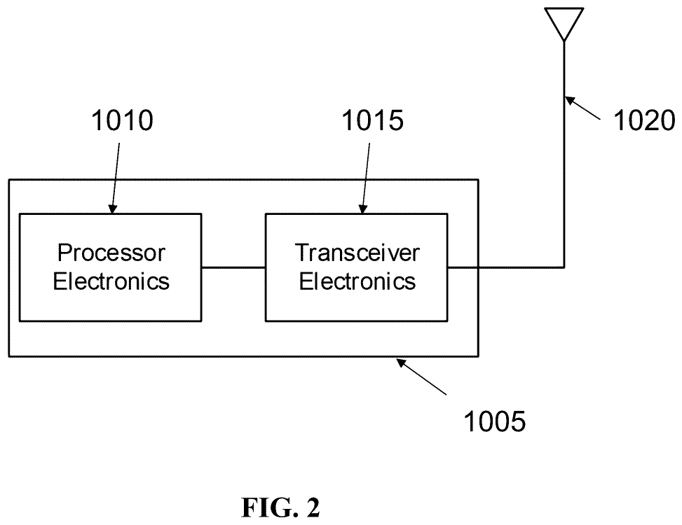

FIG. 3 shows an example of transmission process between a wireless communication device and a network device.

FIG. 4 shows an example of TCI state determination based on dynamic switch indication and based on a time interval.

FIG. 5 shows an example of TCI selection based on a time interval.

FIG. 6 is a flowchart illustrating an example method.

FIG. 7 is a flowchart illustrating an example method.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

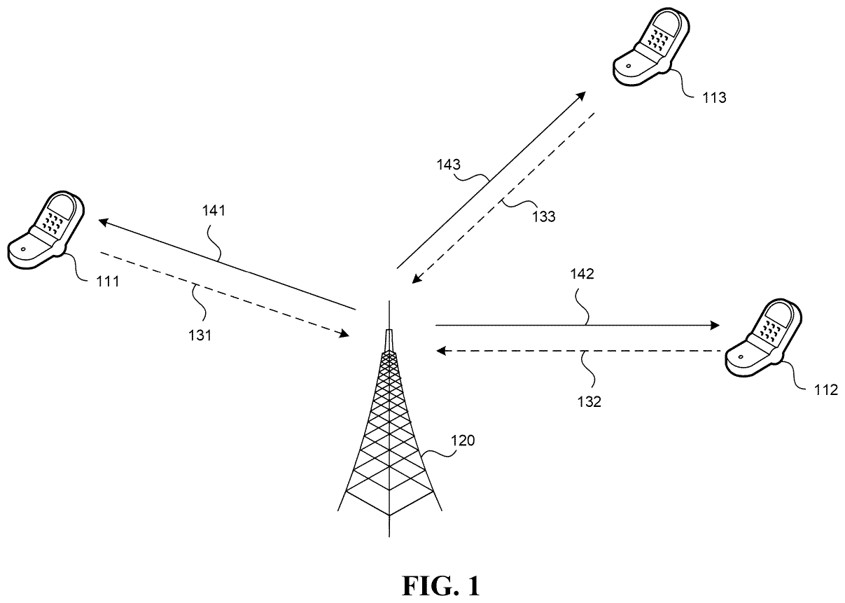

FIG. 1 shows an example of a wireless communication system (e.g., a long-term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

To improve coverage at the cell edge and reduce negative impact of the blocking effect, the Multi TRP (Transmission and Reception Point) (MTRP) technology has become an important technical method in the 5G New Radio (NR) system. With gradually standardized MTRP technology and with the evolution of R16/17, the MTRP technology has improved steadily. In URLLC scenario, one Downlink Control Information (DCI) can schedule multiple PDSCH from different TRPs or schedule multiple PUSCH to face different TRPs. In this scenario, however, if the gNodeB wants to schedule an independent PDSCH, regardless of whether PDSCH is from the TRP where the DCI is sent or from another TRP where indication for UE is unclear, UE would not be able to use the correct beam for receiving.

This document proposes methods to resolve the issue of mode configuration and the TCI state indication for UE when the gNB performs dynamic switching in the MTRP scenario.

A Multi-TRP (Multiple Transmission and Reception Point) approach uses multiple TRPs to effectively improve the transmission throughput in the Long-Term Evolution (LTE), Long Term Evolution-Advanced (LTE-A) and New Radio access technology (NR) in the Enhanced Mobile Broadband (eMBB) scenario. At the same time, the use of Multi-TRP transmission or reception can effectively reduce the probability of information blockage and improve the transmission reliability in URLLC (Ultra-reliability and Low Latency Communication) scenarios.

According to the mapping relationship between transmitted signal flow and multi-TRP/panel, the Coordinated Multiple Points Transmission/Reception can be divided into two types: Coherent transmission and non-coherent transmission. For coherent transmission, each data layer is mapped to multiple-TRPs/Panels through weighted vectors. However, in the actual deployment environment, this mode has higher requirements for synchronization between TRPs and the transmission capability of backhaul links, and is sensitive to many non-ideal factors.

By comparison, Non-coherent Joint Transmission (NCJT) is less affected by the above factors. NCJT used to be a major consideration in R15 Coordinated Multiple Points Transmission/Reception. NCJT means that each data flow is only mapped to the port corresponding to the TRP/Panel with the same channel large-scale parameters (QCL). Different data flows can be mapped to different ports with different large-scale parameters, and all TRPs do not need to be processed as a virtual array.

When gNodeB wants to schedule an independent PDSCH/PUSCH, the current indication is not enough for UE. Therefore, studies on enhancement for dynamic switching are needed.

The embodiments and techniques described in the present document can be used to resolve the above discussed problem.

Note that, in this document, the definition of “beam” is equivalent to quasi-co-location (QCL) state, transmission configuration indicator (TCI) state, spatial relation state (also called as spatial relation information state), reference signal (RS), spatial filter or pre-coding.

The definition of “Tx beam” is equivalent to QCL state, TCI state, spatial relation state, DL/UL reference signal (such as channel state information referencing signal (CSI-RS), synchronization signal block (SSB) (also known as SS/PBCH), demodulation reference signal (DMRS), sounding reference signal (SRS), and physical random-access channel (PRACH)), and Tx spatial filter or Tx precoding.

The definition of “Rx beam” is equivalent to QCL state, TCI state, spatial relation state, spatial filter, Rx spatial filter, and Rx precoding.

The definition of “beam ID” is equivalent to QCL state index, TCI state index, spatial relation state index, reference signal index, spatial filter index, and precoding index.

Specifically, the spatial filter can be either UE-side or gNB-side, and the spatial filter is also known as spatial-domain filter.

Note that “spatial relation information” is comprised of one or more of the reference RSs, where it is used to represent “spatial relation” between targeted “RS or channel,” and one or more reference RSs, where “spatial relation” means the same/quasi-co beam(s), same/quasi-co spatial parameter(s), and same/quasi-co spatial domain filter(s).

Note that “spatial relation” means the beam, spatial parameter, and spatial domain filter.

Note that “QCL state” is comprised of one or more of the reference RSs and the corresponding QCL type parameters, where QCL type parameters include at least one of the following aspect or combination: [1] Doppler spread, [2] Doppler shift, [3] delay spread, [4] average delay, [5] average gain, and [6] Spatial parameter (also known as spatial Rx parameter).

In this document, “TCI state” is equivalent to “QCL state”. The definitions for ‘QCL-TypeA’, ‘QCL-TypeB’, ‘QCL-TypeC’, and ‘QCL-TypeD’ are:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Note that “UL signal” can be PRACH, PUCCH, PUSCH, UL DMRS, and SRS.

Note that “DL signal” can be PDCCH, PDSCH, SSB, DL DMRS, and CSI-RS.

Note that group-based reporting comprises at least one of “beam group” based reporting and “antenna group” based reporting.

Note that the definition of “beam group” means different Tx beams within the same group may be simultaneously received or transmitted, and/or Tx beams between different groups may not be simultaneously received or transmitted. The definition of “beam group” is described from the UE's perspective.

Note that “BM RS” means beam management reference signal, and it can be CSI-RS, SSB or SRS.

Note that “BM RS group” is equivalent to “grouping one or more BM reference signals”, and BM RSs from a group are associated with the same TRP.

Note that “group information” indicates “information of grouping one or more reference signals,” “transmission and reception point (TRP),” “resource set,” “panel,” “sub-array,”“antenna group,” “antenna port group,” “group of antenna ports,” “beam group,” “physical cell index (PCI),” “TRP index,” “CORESET pool ID,” or “UE capability set.”

Note that “TRP index” is equivalent to “TRP ID”, which is used to distinguish different TRPs.

Note that “panel ID” is equivalent to UE panel index.

### Embodiment 1: Dynamic Switch Mode Configuration

In Rel-16, URLLC enhancement for MTRP agreed that 2 PDSCH from 2TRPs can be scheduled.

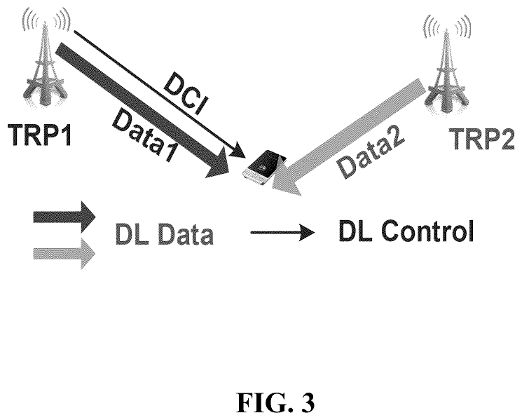

FIG. 3 shows that DCI from TRP1 can schedule data 1 (PDSCH1) from TRP1 and data 2 (PDSCH2) from TRP2 respectively. For Single-DCI based MTRP scenario, there are 4 schemes can be used. Note that FIG. 3 is only one of the exemplary aspects of the schedule data. Schedule data is not to limited to PDSCH, others, such as PUCCH/PUSCH etc., can be used.

Scheme 1a: UE will be indicated with two TCI states in a codepoint of the DCI field ‘Transmission Configuration Indication’ and DM-RS port(s) within two CDM group in the DCI field ‘Antenna Port(s)’.

Scheme 2a: UE will be indicated with two TCI states in a codepoint of the DCI field ‘Transmission Configuration Indication’ and DM-RS port(s) within one CDM group in the DCI field ‘Antenna Port(s)’. At the same time, the repetition scheme will be set to ‘FDMSchemeA’.

Scheme 2b: UE will be indicated with two TCI states in a codepoint of the DCI field ‘Transmission Configuration Indication’ and DM-RS port(s) within one CDM group in the DCI field ‘Antenna Port(s)’. At the same time, the repetition scheme will be set to ‘FDMSchemeB’.

Scheme 3: UE will be indicated with two TCI states in a codepoint of the DCI field ‘Transmission Configuration Indication’ and DM-RS port(s) within one CDM group in the DCI field ‘Antenna Port(s)’. At the same time, the repetition scheme will be set to ‘TDMSchemeA’.

Scheme 4: UE will be indicated with one or two TCI states in a codepoint of the DCI field ‘Transmission Configuration Indication’ and DM-RS port(s) within one CDM group in the DCI field ‘Antenna Port(s)’. At the same time, the repetition number will be set to 2, 3, 4, 5, 6, 7, 8 or 16.

As analyzed above, in the MTRP scenario, the UE will be instructed that a codepoint contains two TCI states for receiving data of the two TRPs. However, when the gNB wants to implement dynamic switch (DCI only needs to schedule data 1 or data 2 transmission), the UE cannot identify which of the multiple TCI states to be used.

The mode should be configured by gNB.

In some implementations, dynamic switch mode can be configured by RRC explicitly, according to one repetition scheme

RepetitionSchemeConfig-r16 ::= CHOICE {

| | |
|---|---|
| fdm-TDM-r16 | SetupRelease { FDM-TDM-r16 }, |
| slotBased-r16 | SetupRelease { SlotBased-r16 } |

}

| | |
|---|---|
| FDM-TDM-r16 ::= | SEQUENCE { |
| repetitionScheme-r16 | ENUMERATED {fdmSchemeA, |
| | fdmSchemeB,tdmSchemeA, dynamicswitch }, |
| startingSymbolOffsetK-r16 | INTEGER (0..7) OPTIONAL -- Need R |

}

| | |
|---|---|
| SlotBased-r16 ::= | SEQUENCE { |
| tciMapping-r16 | ENUMERATED {cyclicMapping, sequenticalMapping}, |
| sequenceOffsetforRV-r16 | INTEGER (1..3) |

In some implementations, dynamic switch mode can be configured by RRC according to a new RRC parameter, such as, DynamicSwitch-r18

In some implementations, dynamic switch mode can be configured by MAC-CE

In some implementations, dynamic switch mode can be indicated by RRC implicitly according to a value of a repetition parameter.

In some implementations, the repetition parameter can be RepNum16 in pdsch-TimeDomainAllocationList. The UE can expect to be indicated with the DCI field “Time domain resource assignment’ indicating an entry in pdsch-TimeDomainAllocationList, which contain RepNum16=N.

Note that N indicates a value other than the values that can be configured in the current spec. (e.g., 0 or 1).

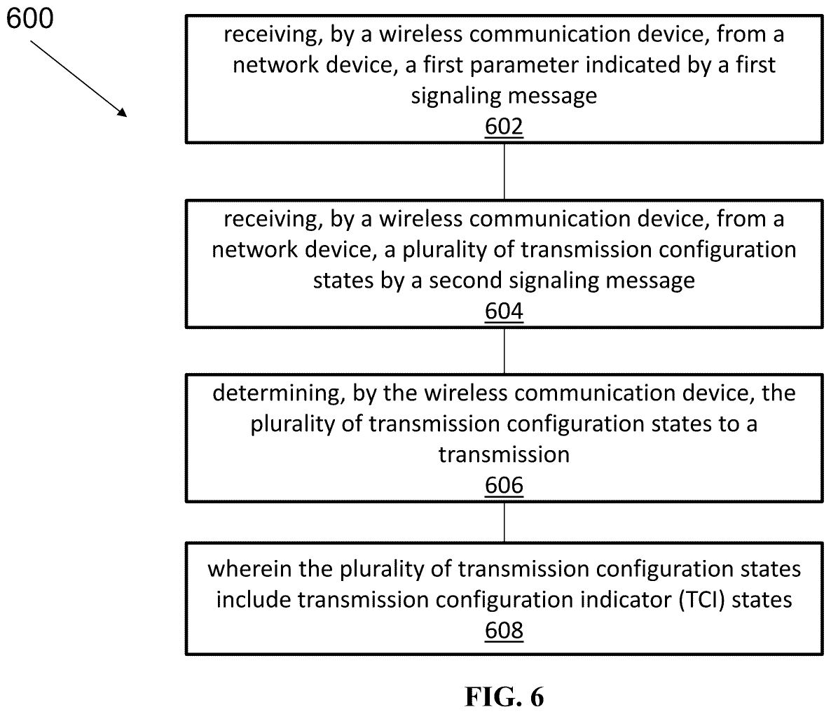

FIG. 6 illustrates a method of wireless communication, comprising: receiving, by a wireless communication device, from a network device, a first parameter indicated by a first signaling message; receiving, by a wireless communication device, from a network device, a plurality of transmission configuration states by a second signaling message; determining, by the wireless communication device, the plurality of transmission configuration states to a transmission; wherein the plurality of transmission configuration states include transmission configuration indicator (TCI) states.

FIG. 6 illustrates a method of wireless communication, comprising: transmitting, by a network device, to a wireless communication device, a first parameter indicated by a first signaling message; transmitting, by a network device, to a wireless communication device, a plurality of transmission configuration states by a second signaling message; determining, by the wireless communication device, the plurality of transmission configuration states to a transmission; wherein the plurality of transmission configuration states include transmission configuration indicator (TCI) states.

### Embodiment 2: TCI State Indication by MAC-CE

After gNB indicates dynamic switching mode according to embodiment 1, the UE further selects from multiple TCI states previously indicated. The specific selection principle can be indicated by MAC-CE.

Explicit indication means that a first index can be used for indicating which TCI state is used for scheduled channels.

For example, the first index is configured for each TCI state, the first index value 1 indicates the TCI state is used for transmission after dynamic switching, and the first index value 0 indicates the TCI state is not used for transmission after dynamic switching.

For example, when multiple codepoints are configured for the MAC-CE, and DCI may select one codepoint for transmission. The following Table 1 shows the configuration of two codepoints for the MAC-CE and DCI choose the first codepoint for UE.

TABLE 1

| | | |
|---|---|---|
| R | Serving Cell ID | BWP ID |

| | | |
|---|---|---|
| C0 | 0 | TCI state#1 |
| R | 1 | TCI state#2 |
| C0 | 1 | TCI state#4 |
| R | 0 | TCI state#3 |

(a) MAC-CE codepoints configuration

| | | |
|---|---|---|
| Codepoint #1 | TCI state#1 | TCI state#2 |

(b) DCI codepoint selection

For example, the first index is configured for each TCI state codepoint, the first index value 0 indicates the first TCI state is used for transmission after dynamic switching, and the first index value 1 indicates the second TCI state is used for transmission after dynamic switching.

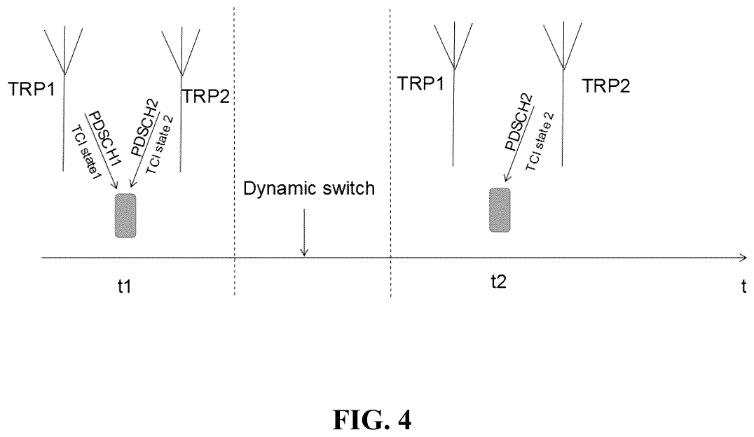

As shown in FIG. 4, based on the above selection, the UE can receive multiple PDSCH at t1. After receiving the dynamic switch indication from the gNB, the UE determines TCI state 2 for subsequent transmission according to the MAC-CE configuration. Therefore, at t2, the UE is only used to receive PDSCH2 from TRP2 associated with the TCI state 2. Note: FIG. 4's use of PDSCH is for exemplary purpose only and should not be taken as to limited to PDSCH. Other forms, such as PUCCH/PUSCH etc., can also be used.

Implicit indication: A default rule can be used for indicating which TCI state is used for scheduled channels.

When one TCI state codepoint has been indicated by DCI, the first TCI state in the codepoint is used for scheduled channels.

When one TCI state codepoint has been indicated by DCI, the TCI state associated with the lowest group information index (e.g., CORESETPoolIndex) in the codepoint is used for scheduled channels.

When one TCI state codepoint has been indicated by DCI, the TCI state associated with the same group information index (e.g., CORESETPoolIndex) with DCI in the codepoint is used for scheduled channels.

When multiple TCI state codepoints have been activated by MAC-CE, the codepoint only contains TCI states associated with the same group information index value and the codepoint with the lowest index is used for scheduled channels.

DCI format:

If the transmission is scheduled by DCI format 1_0/1_1, TCI field is not included in the DCI.

UE will use the TCI codepoint indicated by latest DCI with the TCI field before the DCI.

If the transmission is scheduled by DCI format 1_1, TCI field is included in the DCI.
UE will use the TCI codepoint indicated by the DCI.
UE will use the TCI codepoint indicated by the latest DCI with the TCI field before the DCI.

### Embodiment 3: TCI Indication by DCI

If there is no indication of TCI state used for dynamic switch in MAC-CE as disclosed in embodiment 2, a new DCI field can be introduced to further indicate the TCI state selection.

Method 1: 2 bit can be used for TCI state selection and TCI state transmission order selection.

TABLE 2

| | |
|---|---|
| 00 | Only used TCI state associated with TRP1 |
| 01 | Only used TCI state associated with TRP2 |
| 10 | TRP1, TRP2 order |
| 11 | TRP2, TRP1 order |

As shown in Table 2, 00,01 are used for dynamic switch TCI state selection. Note that “TRP1/2” here is not the real index of TRP, but rather to distinguish different TRPs. 10,11 are used for TCI state transmission order, such as for SDM, schemes 1a/2a/2b/3/4 mode.

Method 2: 2 bit can be only used for TCI state selection.

TABLE 3

| | |
|---|---|
| 00 | Only used TCI state associated with TRP1 |
| 01 | Only used TCI state associated with TRP2 |
| 10 | TRP1, TRP2 order (R17 default order) |
| 11 | Reserved |

As shown in Table 3, which is different from method 1, the transmission order of TRP1/2 can be default, and does not need to be specifically separated.

Method 3: 1 bit can be used for TCI state selection.

Table 4 shows when the dynamic switch mode is configured:

TABLE 4

| | |
|---|---|
| 0 | Only used TCI state associated with TRP1 |
| 1 | Only used TCI state associated with TRP2 |

Table 5 shows when dynamic switch mode is NOT configured (when dynamic switch mode is NOT configured and the field is still used), 1 bit can be used for TCI state transmission order selection.

TABLE 5

| | |
|---|---|
| 0 | TRP1, TRP2 order |
| 1 | TRP2, TRP1 order |

### Embodiment 4: Threshold Between DCI and PDSCH

In the present document, the UE determines the beam used for receiving the PDSCH in accordance with the time interval between the PDCCH and the scheduled PDSCH.

If the time interval is equal to or greater than the defined threshold, the PDSCH is received in accordance with the beam indicated in the PDCCH.

If the time interval is smaller than the defined threshold, the PDSCH is received in accordance with the default beam.

For dynamic switch mode, if the selected TCI states are included in the previous DCI indication, the threshold can be ignored by UE.

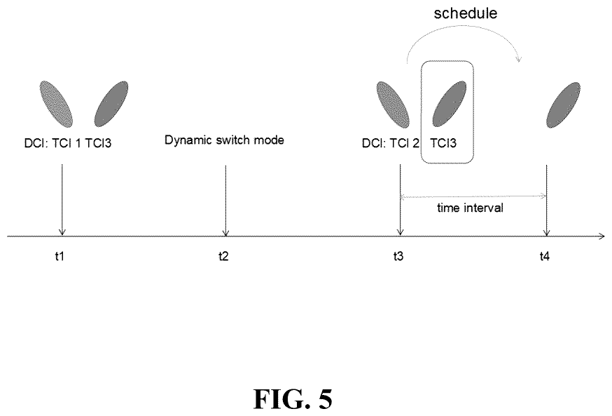

As shown in FIG. 5, at t1, DCI indicates that a TCI codepoint contains TCI 1 and TCI 3, and then dynamic switch mode is triggered at t2. At t3 moment, DCI indicates a codepoint containing TCI 2 and TCI 3. However, according to the previous embodiment 2 or 3, TCI 3 is finally selected, while TCI 3 has been activated in the previous DCI. Therefore, the UE does not need to consider the time interval between PDCCH and PDSCH (t3 to t4). Note: This drawing only takes the PDSCH as an example and is not limited to the PDSCH. It may be PUCCH/PUSCH and so on.

Accordingly, some preferred embodiments may use the following solutions.

1. A method of wireless communication, as shown in FIG. 6, including receiving, by a wireless communication device, from a network device, a first parameter indicated by a first signaling message (602); receiving, by a wireless communication device, from a network device, a plurality of transmission configuration states by a second signaling message (604); determining, by the wireless communication device, the plurality of transmission configuration states to a transmission (606); wherein the plurality of transmission configuration states include transmission configuration indicator (TCI) states (608).

2. The method of solution 1, wherein the first signaling message comprising a Radio Resource Control (RRC) signaling.

3. The method of claim 1, wherein the first signaling message comprising a Medium Access Control-Control Element (MAC-CE) signaling.

4. The method of solution 1, wherein the first parameter indicating a switch mode.

5. The method of solution 1, wherein the first parameter further determining according to the value of a repetition parameter.

6. The method of solution 1, wherein the second signaling message comprising a MAC-CE signaling.

7. The method of solution 1, wherein the plurality of transmission configuration states is determined according to the first index value in the second signaling message.

8. The method of solution 1, wherein the plurality of transmission configuration states determining by a TCI state set indicated by Downlink Control Information (DCI).

9. The method of solution 8, wherein the plurality of transmission configuration states further determining by one or more of the following: the TCI states in the TCI state set in order; the TCI states in the TCI state set associated with the lowest group information index value; and the TCI states in the TCI state set associated with the same group information index value as the group information index of the DCI.

10. The method of solution 1, wherein the plurality of transmission configuration states determining by a codepoint only comprising TCI states associated with the same group information index value and the codepoint is activated by MAC-CE with the lowest index.

11. The method of solution 1, wherein the second signaling message comprising a DCI signaling.

12. The method of solution 11 wherein the DCI signaling further comprising one or more of the following: TCI state selection information, and TCI state transmission order information.

13. The method of solution 11, further comprising, for a TCI field not presented in the DCI, the plurality of transmission configuration states determining by the TCI field in the latest DCI with the TCI field before the DCI.

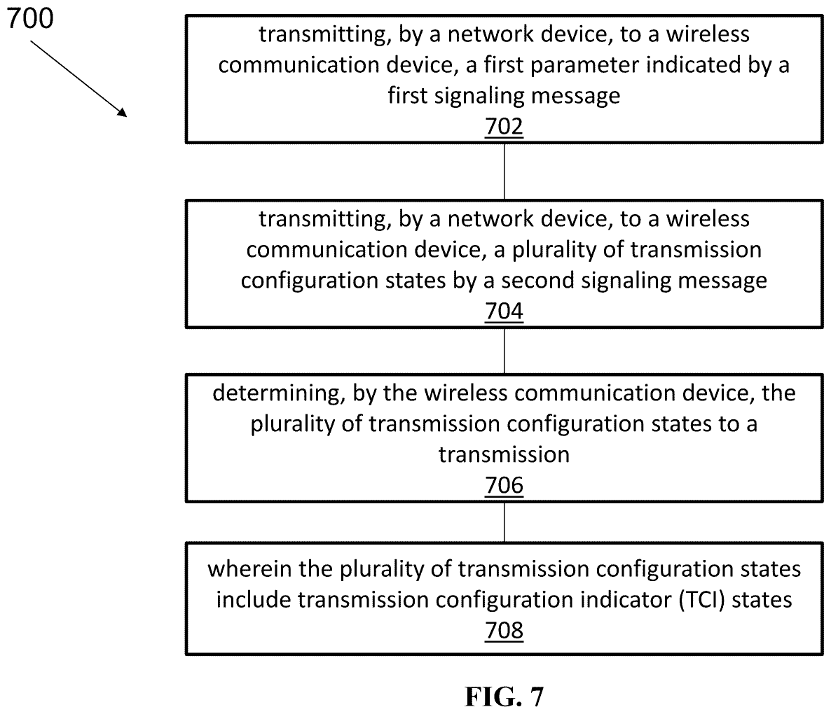

14. A method of wireless communication, as shown in FIG. 7, including transmitting, by a network device, to a wireless communication device, a first parameter indicated by a first signaling message (702); transmitting, by a network device, to a wireless communication device, a plurality of transmission configuration states by a second signaling message (704); determining, by the wireless communication device, the plurality of transmission configuration states to a transmission (706); wherein the plurality of transmission configuration states include transmission configuration indicator (TCI) states (708).

15. The method of solution 14, wherein the first signaling message comprising a Radio Resource Control (RRC) signaling.

16. The method of solution 14, wherein the first signaling message comprising a Medium Access Control-Control Element (MAC-CE) signaling.

17. The method of solution 14, wherein the first parameter indicating a switch mode.

18. The method of solution 14, wherein the first parameter further determining according to the value of RRC parameter.

19. The method of solution 14, wherein the second signaling message comprising a MAC-CE signaling.

20. The method of solution 14, wherein the plurality of transmission configuration states is determined according to the first index value in the second signaling message.

21. The method of solution 14, wherein the plurality of transmission configuration states determining by a TCI state set indicated by DCI.

22. The method of solution 21, wherein the plurality of transmission configuration states further determining by one or more of the following: the TCI states in the TCI state set in order; the TCI states in the TCI state set associated with the lowest group information index value; and the TCI states in the TCI state set associated with the same group information index value as the group information index of the DCI.

23. The method of solution 14, wherein the plurality of transmission configuration states determining by a codepoint only comprising TCI states associated with the same group information index value and the codepoint is activated by MAC-CE with the lowest index.

24. The method of solution 14, wherein the second signaling message comprising a DCI signaling.

25. The method of solution 24 wherein the DCI signaling further comprising one or more of the following: TCI state selection information, and TCI state transmission order information.

26. The method of solution, further comprising, for a TCI field not presented in the DCI, the plurality of transmission configuration states determining by the TCI field in the latest DCI with the TCI field before the DCI

27. An apparatus for wireless communication comprising a processor configured to implement the method of any of claims 1 to 26.

28. A computer readable medium having code stored thereon, the code when executed by a processor, causing the processor to implement a method recited in any of claims 1 to 26.

It will be appreciated that various techniques have been disclosed to allow improvements of cell coverage and reduction of negative impact of the blocking effect. With the gradual standardization of MTRP technology, with the evolution of R16/17, the MTRP technology is basically improved. For URLLC scenario, one DCI can schedule multiple PDSCH from different TRPs or schedule multiple PUSCH facing to different TRPs. However, in this scenario, if the gNodeB wants to schedule an independent PDSCH, whether the PDSCH comes from the TRP where the DCI is sent or from another TRP has no clear indication for the UE. As a result, the UE cannot use the correct beam for receiving. Accordingly, in one beneficial aspect, proposes methods solve the problem of how to configure the mode and the TCI state indication for UE when the gNB performs dynamic switching in the MTRP scenario.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of a document that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

What is claimed is:

1. A method of wireless communication, comprising:
receiving, by a wireless communication device from a network device, a switch mode indicated by a first signaling message, wherein the switch mode is configured to indicate a selection of a transmission configuration indicator (TCI) state from a plurality of TCI states;
receiving, by the wireless communication device from the network device, a codepoint value indicating the plurality of TCI states in a second signaling message;
determining, by the wireless communication device, the TCI state applicable to a transmission based on the switch mode, and
performing the transmission according to the TCI state.

2. The method of claim 1, wherein the first signaling message comprising a Radio Resource Control (RRC) signaling.

3. The method of claim 1, wherein the second signaling message comprising a MAC-CE signaling.

4. The method of claim 1, wherein the second signaling message comprising a Downlink Control Information (DCI) signaling that comprises TCI state selection information.

5. The method of claim 1, wherein the plurality of TCI states is determined based on a TCI state set indicated by a DCI signaling.

6. A method of wireless communication, comprising:
transmitting, by a network device to a wireless communication device, a switch mode indicated by a first signaling message, wherein the switch mode is configured to indicate a selection of a transmission configuration indicator (TCI) state from a plurality of TCI states;
transmitting, by the network device to the wireless communication device, a codepoint value indicating the plurality of TCI states in a second signaling message; and
performing a transmission according to the TCI state that is determined based on the switch mode.

7. The method of claim 6, wherein the first signaling message comprising a Radio Resource Control (RRC) signaling.

8. The method of claim 6, wherein the second signaling message comprising a MAC-CE signaling.

9. The method of claim 6, wherein the second signaling message comprising a Downlink Control Information (DCI) signaling that comprises TCI state selection information.

10. The method of claim 6, wherein the plurality of TCI states is determined based on a TCI state set indicated by a DCI signaling.

11. A device of wireless communication, comprising at least one processor configured to:
receive, from a network device, a switch mode indicated by a first signaling message, wherein the switch mode is configured to indicate a selection of a transmission configuration indicator (TCI) state from a plurality of TCI states;
receive, from the network device, a codepoint value indicating the plurality of TCI states in a second signaling message;
determine the TCI state applicable to a transmission based on the switch mode; and
perform the transmission according to the TCI state.

12. The device of claim 11, wherein the first signaling message comprising a Radio Resource Control (RRC) signaling.

13. The device of claim 11, wherein the second signaling message comprising a MAC-CE signaling.

14. The device of claim 11, wherein the second signaling message comprising a Downlink Control Information (DCI) signaling that comprises TCI state selection information.

15. The device of claim 11, wherein the plurality of TCI states is determined based on a TCI state set indicated by a DCI signaling.

16. A device of wireless communication, comprising at least one processor configured to:
transmit, to a wireless communication device, a switch mode indicated by a first signaling message, wherein the switch mode is configured to indicate a selection of a transmission configuration indicator (TCI) state from a plurality of TCI states;
transmit, to the wireless communication device, a codepoint value indicating the plurality of TCI states in a second signaling message; and
perform a transmission according to the TCI state that is determined based on the switch mode.

17. The device of claim 16, wherein the first signaling message comprising a Radio Resource Control (RRC) signaling.

18. The device of claim 16, wherein the second signaling message comprising a MAC-CE signaling.

19. The device of claim 16, wherein the second signaling message comprising a Downlink Control Information (DCI) signaling that comprises TCI state selection information.

20. The device of claim 16, wherein the plurality of TCI states is determined based on a TCI state set indicated by a DCI signaling.
